(19) United States
(12) Patent Application Publication
(10) Pub. No.: US 2023/0004666 A1
(43) Pub. Date: Jan. 5, 2023

(54) SURVEILLANCE DATA FILTRATION TECHNIQUES

(71) Applicant: DEKA Products Limited Partnership, Manchester, NH (US)

(72) Inventors: Karla BEAGLE, Bedford, NH (US); Raajitha GUMMADI, Manchester, NH (US); Gregory J. BUITKUS, North Andover, MA (US)

(21) Appl. No.: 17/809,599

(22) Filed: Jun. 29, 2022

Related U.S. Application Data
(60) Provisional application No. 63/202,954, filed on Jul. 1, 2021.

(51) Int. Cl. G06F 21/62; G06V 20/52; G06V 10/56; G06V 20/62; G06V 40/10; G06V 10/44; G06F 21/60

(52) U.S. Cl. CPC G06F 21/6218; G06V 20/52; G06V 10/56; G06V 20/625; G06V 40/10; G06V 10/443; G06F 21/602; G06V 2201/08

(57) ABSTRACT

A system for identifying desired information from collected sensor data includes a collection device and a processing module. The collection device collects sensor data, coarsely filters the sensor data according to predefined rules to generate filter matched data, and securely transmits the filter matched data to the processing module. The processing module finely filters the filter matched data to generate desired information, provides the desired information to an authorized actor, and deletes the filter matched data.

### CROSS REFERENCE TO RELATED APPLICATIONS

This application claims priority from U.S. provisional patent application Ser. No. 63/202,954, entitled SURVEILLANCE DATA FILTRATION TECHNIQUES, filed Jul. 1, 2021 (Attorney Docket #AA610), which is hereby incorporated by reference herein in its entirety.

### BACKGROUND

This disclosure relates generally to electronic search or surveillance. More specifically, this disclosure pertains to identifying the locations of subjects of interest to law enforcement agencies and filtering collected data associated therewith.

Autonomous vehicles associated with law enforcement can, for example, determine if an automobile has violated traffic laws, follow the vehicle, and electronically issue a ticket or warning to the violator. Autonomous vehicles can be trained to find good hiding spots to catch traffic violators, aim their cameras to accurately monitor traffic, identify vehicles, analyze incoming data against a database of traffic laws, and communicate with a central computing system and surveillance cameras. Such an autonomous vehicle can record the collected data and transmit the record to government agencies. Autonomous vehicles can also assess environments and the people therein to reduce the risk to law enforcement personnel. For example, drones can observe and interact with a suspect, capture images of the suspect and of associated documents of interest, perform image comparison, perform text extraction and classification, correlate text with image identification, and communicate data to a base station.

Images transmitted can be encrypted, for example, to address privacy concerns. Privacy issues with image dataset collection, for example for surveillance data or medical data, may be addressed with learnable encryption algorithms. And it is possible to photograph and record to investigate incidents such as crime and terrorism while protecting the privacy of people at a high level. For example, cameras can be installed in private vehicles, and the images from such cameras may then be stored for a short period of time, e.g., one to two weeks, in case they are needed by law enforcement.

Common to many of such systems is providing data to law enforcement agencies such that all data collected concerns suspects about whom law enforcement has a right to collect data. However, some of such systems, for example at least autonomous traffic monitoring and environment assessment, may involve collecting a range of data that is not related to anyone or anything about whom law enforcement has the right to collect data. Systems that can identify the locations of subjects and items of interest may not be able to do so while also protecting the privacy of subjects and items that are not of interest.

The above-described background is merely intended to provide a contextual overview of some current issues, and is not intended to be exhaustive.

### BRIEF DESCRIPTION OF THE DRAWINGS

Non-limiting and non-exhaustive aspects of the subject disclosure are described with reference to the following figures, wherein like reference numerals refer to like parts throughout the various views unless otherwise specified.

FIG. 1 is a flow chart depicting flow and steps in accordance with various aspects of the subject disclosure;

FIG. 2 is a flow chart depicting flow and actions in accordance with various aspects of the subject disclosure;

FIG. 3 is a schematic block diagram of a system in accordance with various aspects of the subject disclosure;

FIG. 4 is a message flow diagram depicting message flow in accordance with various aspects of the subject disclosure;

FIG. 5 is a schematic block diagram of an exemplary system of the present teachings;

FIG. 6 is a flow chart depicting flow and steps in accordance with various aspects of the subject disclosure; and

FIG. 7 is a flow chart depicting flow and steps in accordance with various aspects of the subject disclosure.

### DETAILED DESCRIPTION

In the following description, numerous specific details are set forth to provide a thorough understanding of various aspects and arrangements. One skilled in the relevant art will recognize, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” or “a configuration” indicates that a particular feature, structure, or characteristic is described. Thus, appearances of phrases such as “in one aspect,” “in one arrangement,” “in a configuration,” or the like in various places throughout this specification do not necessarily each refer to the same aspect, feature, configuration, or arrangement. Furthermore, the particular features, structures, and/or characteristics may be combined in any suitable manner.

To the extent used in the present disclosure and claims, the terms “component,” “system,” “platform,” “layer,” “selector,” “interface,” and the like are intended to refer to a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server itself can be a component. One or more components may reside within a process and/or thread of execution and a component may be localized on one computer and/or distributed between two or more computers. In addition, components may execute from various computer-readable media, device-readable storage devices, or machine-readable media having various data structures stored thereon. The components may communicate via local and/or remote processes such as in accordance with a signal having one or more data packets (e.g., data from one component interacting with another component in a local system, a distributed system, and/or across a network such as the Internet with other systems via the signal). As another example, a component can be an apparatus with specific functionality provided by mechanical parts operated by electric or electronic circuitry, which may be operated by a software or firmware application executed by a processor, wherein the processor can be internal or external to the apparatus and executes at least a part of the software or firmware application. As yet another example, a component can be an apparatus that provides specific functionality through electronic components without mechanical parts; the electronic components can include a processor therein to execute software or firmware that confers at least in part the functionality of the electronic components.

To the extent used in the subject specification, terms such as “store,” “storage,” “data store,” data storage,” “database,” and the like refer to memory components, entities embodied in a memory, or components comprising a memory. It will be appreciated that the memory components described herein can be either volatile memory or nonvolatile memory, or can include both volatile and nonvolatile memory.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture,” to the extent used herein, is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), digital video disc (DVD), Blu-ray DiscTM (BD)); a smart card; a flash memory device (e.g., card, stick, key drive); a virtual device that emulates a storage device; and/or any combination of the above computer-readable media.

Generally, program modules include routines, programs, components, data structures, etc., that perform particular tasks or implement particular abstract data types. The illustrated embodiments of the subject disclosure may be practiced in distributed computing environments where certain tasks are performed by remote processing devices that are linked through a communications network. In a distributed computing environment, program modules can be located in both local and remote memory storage devices.

Computing devices can include at least computer-readable storage media, machine-readable storage media, and/or communications media. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media that can be used to store desired information. In this regard, the terms “tangible” or “non-transitory” herein as applied to storage, memory, or computer-readable media, are to be understood to exclude only propagating transitory signals per se as modifiers, and do not exclude any standard storage, memory or computer-readable media that are more than only propagating transitory signals per se.

Computer-readable storage media can be accessed by one or more local or remote computing devices, e.g., via access requests, queries, or other data retrieval protocols, for a variety of operations with respect to the information stored by the medium.

A system bus, as may be used herein, can be any of several types of bus structure that can further interconnect to a memory bus (with or without a memory controller), a peripheral bus, and a local bus using any of a variety of commercially available bus architectures. A database, as may be used herein, can include basic input/output system (BIOS) that can be stored in a non-volatile memory such as ROM, EPROM, or EEPROM, with BIOS containing the basic routines that help to transfer information between elements within a computer, such as during startup. RAM can also include a high-speed RAM such as static RAM for caching data.

As used herein, a computer can operate in a networked environment using logical connections via wired and/or wireless communications to one or more remote computers. The remote computer(s) can be a workstation, server, router, personal computer, portable computer, microprocessor-based entertainment appliance, peer device, or other common network node. Logical connections depicted herein may include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, any of which can connect to a global communications network, e.g., the Internet.

When used in a LAN networking environment, a computer can be connected to the LAN through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, a computer can include a modem or can be connected to a communications server on the WAN via other means for establishing communications over the WAN, such as by way of the Internet. The modem, which can be internal or external, and a wired or wireless device, can be connected to a system bus via an input device interface. In a networked environment, program modules depicted herein relative to a computer or portions thereof can be stored in a remote memory/storage device.

When used in either a LAN or WAN networking environment, a computer can access cloud storage systems or other network-based storage systems in addition to, or in place of, external storage devices. Generally, a connection between a computer and a cloud storage system can be established over a LAN or a WAN, e.g., via an adapter or a modem, respectively. Upon connecting a computer to an associated cloud storage system, an external storage interface can, with the aid of the adapter and/or modem, manage storage provided by the cloud storage system as it would other types of external storage. For instance, the external storage interface can be configured to provide access to cloud storage sources as if those sources were physically connected to the computer.

As employed in the subject specification, the term “processor” can refer to substantially any computing processing unit or device comprising, but not limited to comprising, single-core processors; single-core processors with software multithread execution capability; multi-core processors; multi-core processors with software multithread execution capability; multi-core processors with hardware multithread technology; vector processors; pipeline processors; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a state machine, discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. For example, a processor may be implemented as one or more processors together, tightly coupled, loosely coupled, or remotely located from each other. Multiple processing chips or multiple devices may share the performance of one or more functions described herein, and similarly, storage may be effected across a plurality of devices.

As an overview, various arrangements are described herein. For simplicity of explanation, the methods (or algorithms) are depicted and described as a series of steps or actions. It is to be understood and appreciated that the various arrangements are not limited by the actions illustrated and/or by the order of actions. For example, actions can occur in various orders and/or concurrently, and with other actions not presented or described herein. Furthermore, not all illustrated actions may be required to implement the methods. In addition, the methods could alternatively be represented as a series of interrelated states via a state diagram or events. Additionally, the methods described hereafter are capable of being stored on an article of manufacture (e.g., a machine-readable storage medium) to facilitate transporting and transferring such methodologies to computers.

In accordance with an aspect, the system of the present teachings collects data, for example, but not limited to, sensor data, identifies data such as, for example, but not limited to, images of interest, and deletes data that are not of interest. In an aspect, the system encrypts incoming data. In an aspect, the encryption happens in place. In an aspect, all the incoming data are encrypted. The system includes, but is not limited to including, data filtering. In an aspect, the data are filtered to reduce the amount of data required to be transmitted from a collection device to a processing device. In an aspect, the collection devices and the processing devices are operably coupled by electronic communications means. In an aspect, the collection devices and the processing devices are not physically co-located. In an aspect, the collection devices and processing devices are co-located. In an aspect, the collection devices and processing devices share a processor or multiple processors. In an aspect, the data filtering includes a plurality of passes. In an aspect, there are a first pass data filter and a second pass data filter. The present teachings contemplate further filter passes or a single filter pass. In an aspect, the system includes a ruleset processor that can process a filter ruleset. In an aspect, the ruleset processor processes a filter ruleset after at least one criterion is met. For example, but not limited to, the filter ruleset is processed after it is ascertained that the sender of the filter ruleset is an authorized entity. In an aspect, the system deletes data that do not meet selection criteria. The selection criteria can include, but are not limited to including, dynamically-determined criteria, default criteria, and/or criteria established by a user. In an aspect, the system operates in a plurality of modes. In an aspect, the system automatically chooses a mode based upon, for example, the data collected by the collection devices. In an aspect, a user chooses a mode. In an aspect, a default mode is chosen based upon a desired application. In some configurations, the system includes a general mode, a subject mode, and a scene mode. Other modes are contemplated and can be accommodated by the present teachings.

In an aspect, general mode can be likened to the surveillance camera in a store in which the sensor data can be recalled when it is determined that something of interest might have taken place during a specific timeframe. In general mode, the system collects all sensor data that is indicated by, for example, a ruleset, a default set of sensors, or a user-supplied set of sensors. For example, a user may choose to collect LIDAR data, camera data, audio data, and chemical data because a particular application might require point cloud and image data to be collected in a certain geography and in a certain timeframe along with audio and chemical data. Additionally or in the alternative, general mode may indicate by default that all available sensors are activated, and all available sensor data is collected. In one aspect, in general mode the system pre-processes incoming data by filtering the data according to pre-selected criteria such as, for example, but not limited to, blurriness, signal-to-noise ratio, data quality, temporal filtering, or detection of specified objects. In some arrangements further filtering is done according to a pre-selected processing recipe for general data, or according to specific rules that can be provided to the system. In general mode, in an aspect, data remaining after filtering is provided, after being encrypted and, optionally, encoded, to a user to review. In some aspects, for example when a person of interest is being sought, in general mode the user, or system owner, may be a private sector user, and any remaining data are made accessible to the system owner, and are made available for further subject-level filtering and analysis should such be desired. In some aspects, in general mode the user may be a public sector user, and any remaining data is made available for further subject-level filtering and analysis as authorized and configured, but is not made available for public use.

In some aspects, general mode may is used to perform background subtraction. Such background subtraction is used for scenarios in which geographic areas are designated with what subjects are permitted or expected to be present, and the system detects anomalies in such an area and notifies a user that an anomaly has occurred. Such notification may include providing image data and/or other data representing the anomaly. For example, the system may be configured to designate an area that has restrictions or requirements, and provide an alert when needed, e.g., when a car is parked where it should not be parked.

In an aspect, subject mode enables a user to apply image recognition to collected data. For example, if it is necessary to locate a particular person, a type of machine learning model that is used for this purpose is trained to sort through collected data looking for the person in the image. As one of skill would understand, one of many examples of suitable models for face recognition is a neural network model called Deep Face. An example face recognition process follows four steps: (1) face detection, in which one or more faces in an image or video is located and marked with a bounding box; (2) face alignment, in which the detected face (and its location, size, and pose) is normalized to be consistent with the database, as to, e.g., geometry and photometrics; (3) feature extraction, in which features are extracted from the aligned face that can be used for recognition; and (4) feature matching of a feature vector representing the face against one or more known faces in a prepared database (e.g., a database of enrolled users). In an aspect, the system has a separate module or program for each of the four steps, or combines some or all of the steps into a single process. Likewise, if it is necessary to locate an object such as a license plate, a type of machine learning model that is used for this purpose is trained to sort through collected data looking for the specific license plate. As one of skill would understand, one of many examples of suitable models for license plate detection and identification is distributed by Plate Recognizer. In an examplary license plate detection and identification process, a first object detection model is used to recognize an image of a car or other vehicle in multiple images and/or video. In an aspect, a detection model is used to identify license plates in images of cars or other vehicles. The detection model(s) need not be machine learning models. If machine learning models are used, neural networks such as, e.g., YOLO or SSD (both defined below), may be trained to detect license plates. Optical Character Recognition (OCR) may be performed for detected license plates to convert images to text. In an aspect, in subject mode, if data collection and data processing are accomplished in geographically remote (as to each other) processors, at the data collection location, the data are subjected to a first pass filtering process. The first pass filtering process sorts through the data to identify, for example, bounding boxes for objects, sorting the subject from the rest of the data, which are omitted. The data within the bounding boxes are transmitted from a data collection module to a processing module that subjects the data to further filtering. In an aspect, the processing module selects a machine learning model that would be appropriate for the selected subject type such that, when the collected data arrives at the processing module, a subject-specific machine learning model is applied to the data. Possible matches are located, and non-matches are deleted. The possible matches are provided to, for example, a handheld device, tablet, or laptop user interface, a log file, and/or a local or remote system operator desktop user interface. In various configurations, multiple filtering passes execute in the same processor. Additionally or in the alternative, multiple filtering passes execute at a data collection location. Additionally or in the alternative, multiple filtering passes execute remotely from the data collection location. Additionally or in the alternative, multiple filtering passes execute at various processors, local and remote from the data collection location.

Various machine learning models are known to those of skill and may include, as non-limiting and non-exhaustive examples, clustering, dimensionality reduction, ensemble methods, neural nets (e.g., convolutional neural network models) and deep learning, transfer learning, reinforcement learning, natural language processing, and word embeddings. Many suitable techniques for object detection and recognition would be readily appreciated by one of skill in the art, including, by way of non-limiting example, Region-based Convolutional Neural Network (R-CNN), Fast R-CNN, Faster R-CNN, Region-based Fully Convolutional Network (R-FCN), Histogram of Oriented Gradients (HOG), Single Shot Detector (SSD), Spatial Pyramid Pooling (SPP-net), and You Only Look Once (YOLO).

In one example, in subject mode, a system in accordance with the subject disclosure receives an electronic warrant from an authorized entity that can be used to create and/or augment a filter ruleset. The new filter ruleset can effectively authorize an autonomous vehicle to be on the lookout for a vehicle of interest, for example, a Black Hummer H1 with a particular license plate, by passing the filter ruleset to a collection device. A collection device may be incorporated within the autonomous vehicle of the present teachings. Additionally or in the alternative, the collection device may be located remote from, or at least in part remote from, the autonomous vehicle and communicatively coupled thereto. As the autonomous vehicle collects data, the data are compared against the filter ruleset, for example, a list of vehicles included in all active warrants. In an aspect, data associated with vehicles that match a vehicle listed in an active warrant are stored and passed to a processing module, and possibly made available to law enforcement, based on further processing conducted by the processing module. When the vehicle of interest is detected, a law enforcement agent listed on the warrant is notified that the vehicle has been detected and provided the date/time of such detection. In an aspect, the law enforcement agent can securely view and possibly download an image of the vehicle of interest.

In some configurations, a system in accordance with the subject disclosure may operate in a scene mode. The scene mode enables a user to apply scene of interest rules to collected data. In an aspect similar to that for operation in subject mode, a particular scene of interest (like a particular subject of interest) may appear in view of the data collector at any time. Criteria for recognizing a scene of interest may not be specific to a particular location, but may instead provide general characteristics of what such a scene might be. For example, if a machine learning model is trained with the general characteristics of an arson scene, the data collector recognizes possible arson scenes. In scene mode, a trained machine learning model is used in either the data collector or, in an arrangement wherein two data processing passes are available, e.g., one at the data collector and another in a processing system, in the data collector and also in the processing system. Scenes that are identified by the machine learning model are provided to a user, a computer, a log file, and/or various types of display, and the remaining data are deleted.

In an aspect, the system of the present teachings includes a collection processor configured to receive sensor data and encrypt the received sensor data. In various aspects, a collection processor and one or more sensors are mounted upon, for example, an autonomous vehicle, a utility pole, and/or a drone, and/or the collection processor and sensor(s) are carried by a human or animal. In an aspect, the collection processor is configured to execute coded instructions stored in its memory, or in a memory coupled to the collection processor, to filter the sensor data. In an aspect, data that are filtered out are deleted. In an aspect, sensor data are retained for which the filter indicates a likely match, for example, a probability of a match at or above a predefined threshold probability. To perform filtering, a collection processor in some configurations locates features in received sensor data and match those features, if possible, to any of the items in a list of possible features that are of interest, e.g., a trigger list, provided in accordance with a filter ruleset. In an aspect, the trigger list is created from rules that are established by, for example, but not limited to, law enforcement and/or municipal officials. In an aspect, the trigger list includes a subset of an entire set of rules so that processing requirements for the collection processor can be reduced or minimized in order to reduce power consumption. In an example, a trigger list includes facial data of suspect individuals or missing people, and the collection processor looks for matches between the facial data in the trigger list and received sensor data and/or filtered sensor data. Those skilled in the art would readily appreciate that many types of sensor data may be collected, and the trigger list may include triggers for many kinds of data. For example, if the trigger is an object, object detection may be performed using a technique according to various methods known to one of skill, including, but not limited to R-CNN, Fast R-CNN, Faster R-CNN, R-FCN, HOG, SSD, SPP-net, and YOLO. Other types of sensor signals and/or other types of data may be detected and collected such as, by way of non-limiting examples, LIDAR signals, radar signals, ultrasonic waves, optical camera data, audio data (such as, e.g., voice or music data), chemical data, infrared signals, magnetic or near field waveforms, electromagnetic or radio frequency waveforms, point cloud data, bitmaps, alphanumeric data (such as, e.g., automobile license plate numbers), video data, detected faces, and other types of detected objects.

In an aspect, a collection processor is configured to ensure that collected data are maintained in a secure state whether the data are stored locally or are being transmitted to a remote location such as, e.g., a processing station. For example, the collection processor is configured to encrypt all data as the data are received. In an aspect, the collection processor is configured to re-encrypt decrypted data, in the transmit chain, certain elements of the data that have been selected for transmission to the processing station. Various known encryption techniques may be used, such as, by way of non-limiting example, Advanced Encryption System (AES) 256-bit encryption, as would be understood by those of skill. Additionally or in the alternative, the collection module authenticates the data, for example, by ensuring that the data are digitally signed before the data are transmitted to enable a receiver to prove the identity of the sender upon receipt of the data. Additionally or in the alternative, the collection module associates metadata, for example time and/or location data, with the transmitted data. Additionally or in the alternative, the data to be transmitted to the processing station are compressed in order to save bandwidth. Compression may be accomplished using any of various known, standardized methods such as, by way of non-limiting examples, vocoding for voice data, ITU-T H.264, HEVC, or VVC for video data, Huffman coding, lossless compression, or lossy compression, as those of skill would understand. Additionally or in the alternative, a checksum is appended to the data to be transmitted to the processing station in order to enable a receiver at the processing station to detect any errors caused by the transmission medium. Additionally or in the alternative, the data to be transmitted to the processing station are encoded such that a receiver can decode the data to correct for errors caused by the transmission medium. As one of skill in the art would understand, error-correction encoding may be accomplished using various known techniques including, as non-limiting examples, block coding, e.g., Reed-Solomon coding, convolution encoding, turbo encoding, low-density parity check (LDPC) encoding, or polar encoding. Those skilled in the art would also appreciate that the error-correction encoding format employed could depend on the communication protocol being used for transmission. In some aspects, when compression, encryption, and error-correction encoding are performed on data prior to transmission of the data, the data may first be compressed, then the compressed data may be encrypted, and then the encrypted compressed data may be error-correction encoded.

In some arrangements, a collection processor uses one or more of various known machine learning models to perform feature extraction and matching in which computations are performed on the autonomous vehicle (e.g., at an edge node rather than in the cloud). In an aspect, such feature matching targets set of features, which are predefined in a ruleset. The collection module applies tracking, including, e.g., temporal filtering of objects during object detection. Such filtering includes a first type of filtering and a second type of filtering that may be performed by a remote processor at a processing station (e.g., in the cloud). In an aspect, the first type of filtering includes coarse-grained filtering relative to the second type of filtering. In an aspect, the collection module utilizes a two-dimensional (2D)-bounding box tracking mechanism such as, e.g., Generalized Intersection Over Union (GIOU) tracking, to track objects and their bounding boxes from each collected image frame to the subsequent collected image frame. In other arrangements, the collection module tracks objects using a Joint Probabilistic Data Association Filter (JDAF) algorithm, a linear velocity prediction technique, and/or a combination of the two. The collection module, in some aspects, crops one or more, or all, sections of an image within the bounding boxes of the object of interest, as defined by a ruleset. The collection module transmits data to a remotely located processing station, or to a collocated processing station, at least one such cropped image pertaining to a detected and tracked object of interest. In an aspect, the collection module compresses, encrypts, and/or encodes the cropped image before transmitting the cropped image.

A system in accordance with some aspects of the subject disclosure includes a processing module (for example a processing station, or at a processing station) that is configured to receive and process filters or triggers that are used to sort collected data. In an aspect, the processing module receives inputs such as, for example, but not limited to, a trigger and an accompanying authorization to search for the trigger. The trigger includes, for example, but not limited to, objects, images, odors, sounds, scenes, and/or other sensory data. In addition or in the alternative, the processing module receives such identifying information as, for example, but not limited to, location(s) of one or more scenes of interest, duration(s) of one or more sounds of interest, and/or one or more notifications such as, e.g., communications from a collection device or from a human, or automated messages, including notifications of matches or probable matches between collected image data and scenes or subjects of interest. In some examples, a processing module is configured to receive and execute instructions provided via inputs received from an end user application. The end user application, in an aspect, is used to request a ruleset to be applied by the processing module. In various embodiments, the processing module itself includes a manager program. The manager program, in some embodiments, is a cloud-based manager. The manager program is designed to, among other things, maintain one or more of data privacy, data security, chain-of-custody control, and/or audit trail (such as, for example, time or data stamping). In an aspect, the manager program is ruleset agnostic, i.e., the manager program is not limited to processing rulesets encoded in any one specific format. In some configurations, the manager program includes instructions that enable provision of an applications programming interface (API) for privacy, chain of custody, and/or auditing rules to be set by users, such as, by way of non-limiting example, police, government authorities, national security agencies, or commercial customers with special privacy needs.

In various configurations, a processing module and a collection module (for example, a collection processor) communicate with each other through, for example, a gateway. In an aspect, the gateway establishes a web service between the collection module and the gateway, and establishes communications between the collection module and the gateway using the web service, as would be understood by one of skill in art. In some configurations, the gateway is a web server of the web service, and the collection module is a web client of the web service. In an aspect, data are communicated between the collection module and the gateway using the web service.

A processing module in accordance with various arrangements is configured to use encryption keys associated with encrypted data received from a collection module to decrypt the data received from the collection module. Additionally, the processing module is configured to, optionally, re-encrypt data received from a collection module that has been decrypted. In some aspects, the processing module verifies and tracks chain of custody and/or digital signatures associated with incoming data, and/or enables digital signing of some or all outgoing data that the processing module transmits. In various arrangements, the processing module receives rulesets and, based at least in part thereon, prepares and transmits to a collection module a subset (for example, a trigger list) of one or more rulesets for the collection processor to use. In various aspects, the processing module applies a fine-grain filter to coarsely filtered data received from a collection module, and applies a ruleset to the filtered data. A filtered outcome including at least matched data and a match notification are transmitted to, for example, an authorized individual, a log file, a cloud-based system, a laptop, a handheld device, a desktop, and/or a tablet.

A processing module in accordance with various aspects uses any of various machine learning models to subject data received from a collection module to a finer, e.g., more detailed, version of feature matching than a relatively coarse feature matching computation that was performed by the collection module. For example, the processing module determines data that meet trigger requirements described in a ruleset for the filter. In some aspects, a processing module includes at least an extraction algorithm and a recognition algorithm. In an aspect, the extraction algorithm is used to decrypt and/or to decode sensor data that had been collected and filtered previously by a collection module. In an aspect, the extraction algorithm includes at least a neural network algorithm configured to receive decoded, filtered sensor data and generate bounding boxes containing the desired sensor data. In some aspects, the extraction algorithm processes detected sensor data provided by the neural network algorithm. In some aspects, the recognition algorithm subjects detected sensor data to further processing such as, for example, but not limited to, optical character recognition algorithms. Additionally or in the alternative, the recognition algorithm filters the resulting data, such as, for example, text matching between text generated from the data and a trigger value such as a license plate number described in the filter ruleset to classify the text as a match/no-match. In an aspect, the processing module stores the result from the further processing. In an aspect, the storage is secure. In an aspect, the processing module encrypts the storage area so that the data are accessible only by authorized users based on received trigger data. In an aspect, the processing module sends notification(s) when a match is found between the data and a trigger database by, as a non-limiting example, sending a text to the authorized user. In an aspect, the processing module allows an authenticated user to view and download matched data and the location(s) of collection of the matched data. In an aspect, the viewing is secure. In an aspect, data that do not provide a match in accordance with a trigger list are not made available to the authorized individual, or to anyone else, in order to protect the privacy of people who are not of interest. Such data may be deleted, or such data may be encrypted and stored. It would be appreciated by those skilled in the art that a system in accordance with the subject disclosure need not be limited to detecting and/or recognizing only facial features. One of skill would understand that machine learning models can be trained to recognize many types of objects, including but not limited to, e.g., license plates, automobiles, animals, and consumer goods.

A system in accordance with the subject disclosure may be used in various different ways, each invoking privacy and security concerns that are addressed by the architecture of the system. For example, if the system is being used to locate a person for whom a search warrant is outstanding, and the system is executed by an autonomous vehicle, for example, the system collects a substantial number of images of non-suspect individuals. An example system prevents locations and/or activities of non-suspect individuals from being made available to law enforcement. Filtering and encryption by collection modules and processing modules may enable images that are substantially similar in appearance to the suspect to be provided to law enforcement. On the other hand, a system in accordance with the subject disclosure may be used to scan the environment in general without searching for any particular individual or item of interest. In the act of scanning the environment, the system may detect evidence that a crime was committed, or may detect a crime being committed. An example system ensures that images that are captured are not disqualified as evidence, and/or that captured images provided to authorities do not include data that may implicate innocent people. A system according to the subject disclosure accomplishes the foregoing by, for example, but not limited to, assessing incoming data based on rules set by authorities.

As would be readily appreciated by those skilled in the art, AES-256 encryption may be used in a collection module and/or in a processing module in accordance with the subject disclosure when symmetric key encryption is required, such as, e.g., for data-at-rest encryption for datastores such as, e.g., object, relational, directory, and/or search datastores. The AES-256 encryption algorithm may also be used to encrypt message blocks exchanged between the collection module and the processing module over a network. Such messages may also or in the alternative be encrypted with TLS 1.2 encryption used for computer network channels.

As would also be appreciated by one of skill, messages containing data exchanged between a collection module and a processing module in accordance with the subject disclosure may be digitally signed, and a cryptographic hash may be generated for each such message. A recipient of the message may decrypt the message using a public key certificate of the sender. A cryptographic hash may again be generated, at the recipient. Both cryptographic hashes may be compared to verify message authenticity. If the two cryptographic hashes match, then the message may be deemed valid. RS-2048 encryption may be used for digital signatures.

In some aspects, access to data requires user authentication and authorization. Multi-factor authentication using at least two strong authenticators may be desirable in situations involving law enforcement authorities, for example. A user who has been authenticated may be authorized to view specific data as defined using role-based access controls that limit access based on, e.g., subject, time frame, geography, and/or various other parameters.

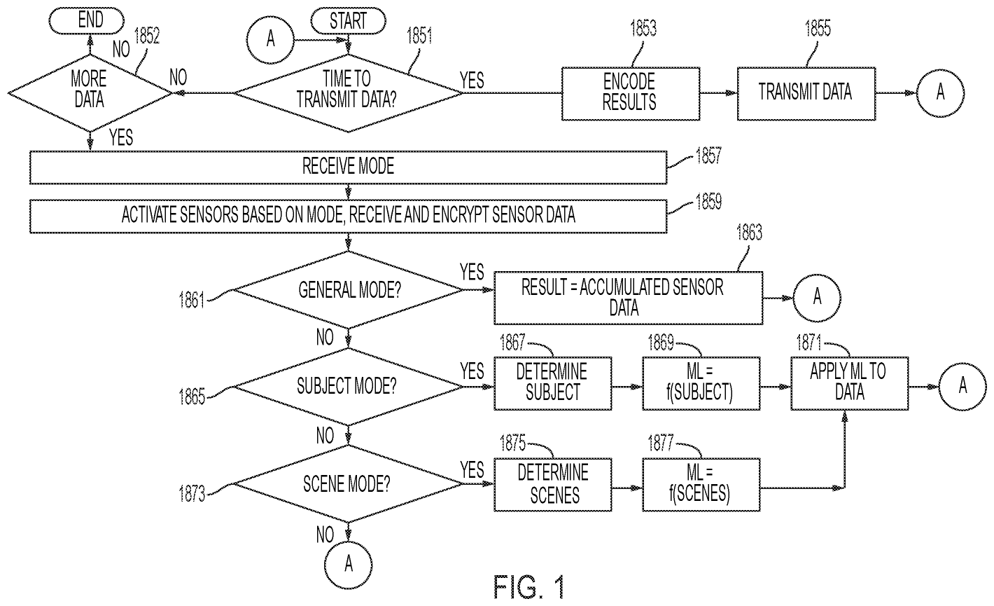

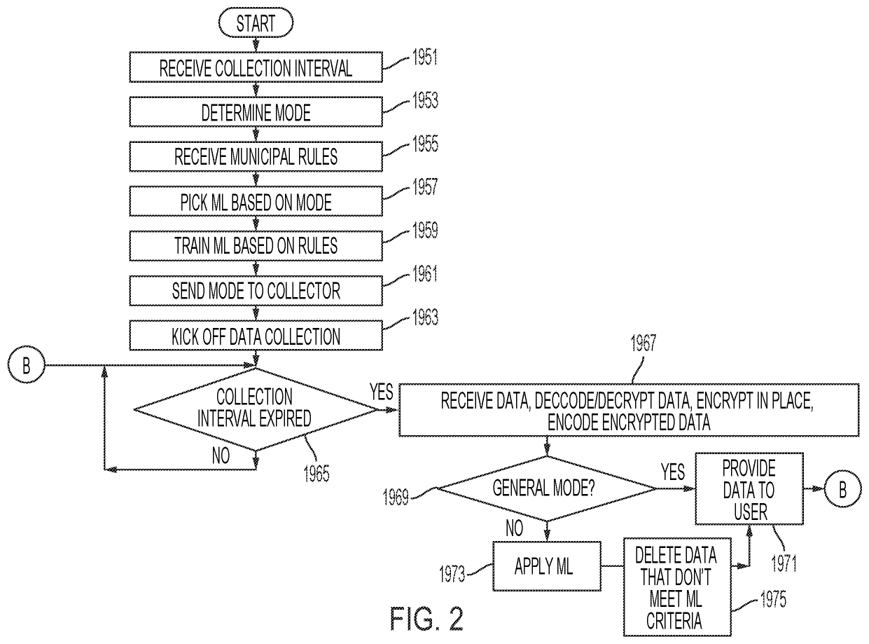

In some configurations, a system may perform first pass processing, assuming that first and second pass processors will be transferring data between each other, in accordance with the method depicted in FIG. 1. In some aspects, second pass processing may be performed in accordance with the method depicted in FIG. 2. With reference to FIG. 1, in action 1851, if it is not time to transmit data, e.g., if a desired amount of data has not been collected, or a time limit for collecting data has not expired, or some other known criterion for ceasing data collection has not been met, flow control proceeds to action 1852. In action 1852, if there are no more data to process, the first pass processing ends. If in action 1852 there are more data to process, control flow proceeds to action 1857. In action 1857, the system receives (for example, from a second pass processor) a desired mode. The mode may be established by a system user, be a default mode, be determined by a choice of application made by a user, be determined by a suite of one or more sensors, or be selected in any of various other appropriate ways. While the mode may be set by a system user, the mode could, in the alternative, be determined dynamically by a data collection system. Control flow then proceeds to action 1859.

In action 1859 the system activates one or more sensors based on the determined mode, and receives and encrypts data from the one or more sensors. If the mode has previously been determined and the sensors are activated, the system continues receiving and encrypting data. Control flow then proceeds to action 1861. In action 1861, if the mode is general mode, control flow proceeds to action 1863. In action 1863, the system accumulates sensor data received from activated sensors. In some configurations, the system supports dynamic adjustment of a set of activated sensors based at least on, e.g., occurrence of a sensor failure, or if at least some of the collected sensor data indicates that other sensors should be activated. If in action 1861 it is determined that the mode is not general mode, control flow proceeds to action 1865.

In action 1865, if the mode is subject mode, control flow proceeds to action 1867. In action 1867, the system determines the type of subject desired. As non-limiting examples, the desired subject could be a human being, an animal, or an object. Control flow then proceeds to action 1869, in which the system may, in some configurations, select a trained machine learning model, the selection being based at least in part on the type of subject. Control flow then proceeds to action 1871, wherein the system applies a selected, trained machine learning model to the sensor data. In some aspects, in a first pass of processing, the selected machine learning model is trained to identify sensor data that meet the characteristics of the subject generally, but may not meet the characteristics of the subject more specifically (e.g., more detailed, fine, or granular characteristics). In some aspects, first pass processing and second pass processing are combined to enable the system to identify a specific subject in a single pass. Moreover, as those of skill would understand, it is possible to tune the first pass processing relative to the second pass processing (or vice versa) to achieve optimum results based on the type of subject. In other words, the relative coarseness of first pass filtering and the relative fineness of second pass filtering may be adjusted, or tuned, with respect to each other as desired. An example of first pass processing when a subject is human is to identify all sensor data that meet the criteria of humanness according to the trained machine learning model, and delete the rest of the data. If in action 1865 it is determined that the mode is not subject mode, control flow proceeds to action 1873.

In action 1873, if the mode is scene mode, control flow proceeds to action 1875. In action 1875 the system may determine the type of scene desired. In some arrangements the general characteristics of possible scenes of interest, as a non-limiting example, crime scenes, may be previously known. In other aspects the general characteristics of possible scenes of interest, as a non-limiting example, crime scenes, may be supplied by a system user. Control flow then proceeds to action 1877, in which the system selects one or more machine learning model, based at least in part upon the type(s) of scene(s) of interest. Control flow then proceeds to action 1871, wherein the system applies one or more selected machine learning models, trained to identify specific types of scenes, to collected sensor data. Additionally or in the alternative, applying multiple machine learning models to collected data are done as part of second pass filtering.

In action 1851, if a desired amount of data have been collected, or a data collection time limit has expired, or some other criterion for ceasing data collection has been met, flow control proceeds to action 1853. In action 1853 the system encodes the data generated by filtering, e.g., in some configurations by filtering with one or more machine learning models. Control flow then proceeds to action 1855, in which the system transmits the data to a second pass processor. Control flow then returns to action 1851, in which a timer for cessation of data collection may be reset, if applicable, and data collection and processing continue.

In some aspects, should a second pass processing be necessary, a system performs a second pass processing in accordance with the method depicted in FIG. 2. It would be understood by those skilled in the art that first pass processing and second pass processing may be performed by a single processor executing coded instructions. In some configurations, a second pass processor interfaces with a system user such that the user interacts with the second pass processor, for example by way of an application. A user interface can be optional, and may be accomplished by at least defaults, recipes, and/or dynamically determined criteria.

With reference to FIG. 2, in some configurations, in action 1951 a system determines a data collection interval. The data collection interval may be a default value, or it may be specified by a system user, or it may be dynamically determined based on, as non-limiting examples, a number of available sensors or a number of types of available sensors or a number of each type of sensor available. Control flow then proceeds to action 1953, in which the system determines a desired mode. In various aspects, a system user may set the desired mode, or the desired mode may be determined dynamically by the system, or the desired mode may be established based at least in part on information requested by a system user. Control flow then proceeds to action 1955, in which the system receives rules that govern which parts of collected data are relatively more significant. For example, the rules may include an image of a person of interest or a designation of a scene of interest. The rules may be established, for example, by law enforcement agencies or other interested authorities or individuals. Control flow then proceeds to action 1957.

In action 1957 the system selects one or more machine learning models based at least upon the determined mode. Additionally or in the alternative, one or more machine learning models is selected based at least in part on the received rules or on other criteria that those of skill would appreciate. In some configurations, models other than machine learning models are deployed. Control flow then proceeds to action 1959. In action 1959 the system trains one or more selected machine learning models based on received rules. For example, if specific people are subjects of interest, a selected machine learning model can be trained to find matches between the collected data and the images of the subjects of interest. In configurations in which multiple processors are deployed, control flow proceeds to action 1961, in which the system provides the desired mode to a first pass processor coupled to or associated with, e.g., a data collection module. Control flow then proceeds to action 1963, in which the system instructs the first pass processor to begin data collection. Control flow then proceeds to action 1965, in which the system determines whether a data collection time interval has expired. If the data collection time interval has expired, control flow proceeds to action 1967. In action 1967, the second pass processor receives data from the first pass processor, and if applicable, the second pass processor decodes the received data and/or either decrypts the received data or encrypts the received data, and/or encodes the received data for transmission or provision. Control flow then proceeds to action 1969.

In action 1969 the system determines whether an operating mode is a general mode rather than, e.g., a subject mode or a scene mode. If the operating mode is determined to be a general mode, control flow proceeds to action 1971. In action 1971 the system provides the data to a system user for evaluation, or, depending at least in part upon the application, the system subjects the data to further processing or filtering. If in action 1969 the operating mode is determined not to be general mode, i.e., the operating mode is determined to be one of subject mode or scene mode, control flow proceeds to action 1973. In action 1973 the system applies a trained machine learning model to the data to generate, as a subset of the data, matched data by determining whether there are any matches in the data to a specific, desired subject, to a scene in which a system user has interest, or to a scene dictated by received rules (as a non-limiting example, a scene indicating that a crime was or is being committed). Control flow then proceeds to action 1975, in which the system deletes any or all data that is not the matched data. Control flow then proceeds to action 1971. In some aspects, after the data have been evaluated by a system user, additional data are collected. In some aspects, the operating mode and/or the rules are changed before data collection is resumed.

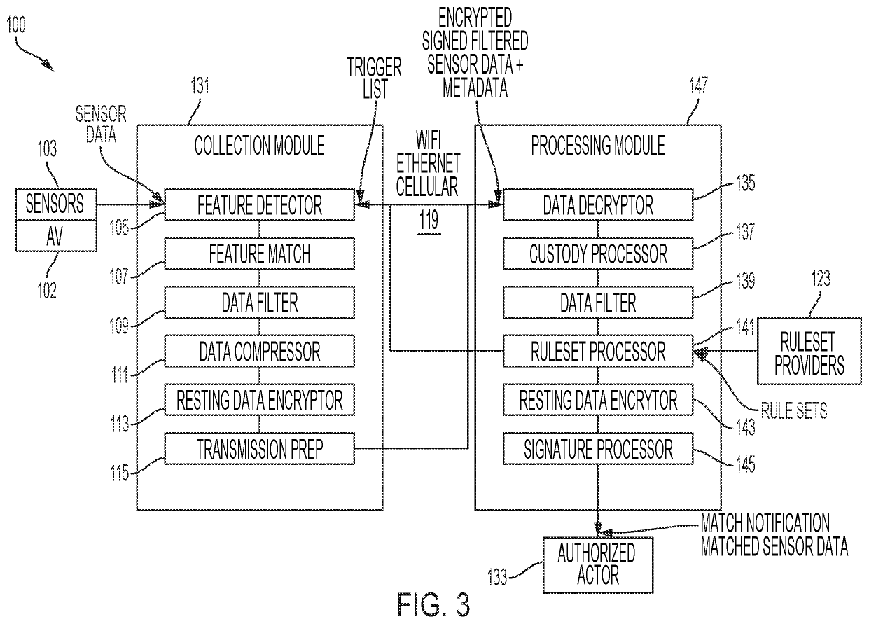

With reference to FIG. 3, system 100 in accordance with various aspects may selectively process images based on predefined criteria. The system 100 includes at least a collection module 131 and a processing module 147. In an aspect, the collection module 131 is coupled to the processing module 147 by a communication medium 119. The communication medium 119 may be a wired connection such as, e.g., Ethernet, or the communication medium 119 may be a wireless connection such as, e.g., WiFi or a cellular or broadband network, among others. In some arrangements, data may be encrypted in transit across the communication medium 119. In some configurations, the collection module 131 and/or the processing module 147 implemented as processors (not shown) executing coded instructions stored in memories (not shown) accessible thereby and/or integral thereto. In some aspects, the collection module 131 and the processing module 147 are remotely located from each other. In other aspects, the collection module 131 and the processing module 147 are collocated. In some aspects, the collection module 131 and the processing module 147 are implemented as a single processor.

In an arrangement the collection module 131 includes one or more of a feature detector 105, a feature matching processor 107 coupled to the feature detector 105 or integral therewith, a data filter 109 coupled to the feature matching processor 107 or integral therewith, a data compressor 111 coupled to the data filter 109 or integral therewith, a resting data encryption module 113 coupled to the data compressor 111 or integral therewith, and a transmit chain 115 coupled to the resting data encryption module 113 or integral therewith. The data filter 109 performs a first filter type on received data. In some configurations, the resting data encryption module 113 encrypts and digitally signs the data such that a receiver can verify the identity of the sender and/or determine whether received data has been altered. The transmit chain module 115 provides forward-error correction coding and/or modulation of filtered, encrypted, digitally signed, sensor data for transmission via the communication medium 119. In an aspect the transmit chain module 115 provides forward-error correction coding and/or modulation of metadata (e.g., timestamps and/or GPS locations) for transmission via the communication medium 119. In some examples, data recipients verify using metadata (e.g., a GPS location and a timestamp) whether the collection module 131 were present at the indicated location at the indicated time. Any or all of the feature detector 105, feature matching processor 107, data filter 109, data compressor 111, resting data encryption module 113, and/or transmit chain 115 may be implemented in hardware (e.g., ASIC or FPGA), software or firmware modules, or as one or more processors, microcontrollers, or state machines executing code stored in memory. The collection module 131, and the feature detector 105, feature matching processor 107, data filter 109, data compressor 111, resting data encryption module 113, and transmit chain 115 may function substantially as described above with respect to the various features of FIGS. 1 and 2.

In an aspect, the processing module 147 includes one or more of a data decryption module 135, a custody processor 137 coupled to the data decryption module 135 or integral therewith, a data filter 139 coupled to the custody processor 137 or integral therewith, a ruleset processor 141 coupled to the data filter 139 or integral therewith, a resting data encryption module 143 coupled to the ruleset processor 141 or integral therewith, and a signature processor 145 coupled to the resting data encryption module 143 or integral therewith. The data decryption module 135 performs decryption using public and private keys. Those of skill would understand that a private key is a key that always resides with an authorized entity that uses the key to decrypt received data. The custody processor 137 tracks chain of custody. The data filter 139 performs a first type of filtering on received data. The signature processor 145 may verify a digital signature associated with a packet of data prior to using the data in order to prove that the data originated with a trusted source. Any or all of the data decryption module 135, custody processor 137, data filter 139, ruleset processor 141, resting data encryption module 143, and/or signature processor 145 may be implemented in hardware (e.g., ASIC or FPGA), software or firmware modules, or as one or more processors, microcontrollers, or state machines executing code stored in memory. The processing module 147, and the feature data decryption module 135, custody processor 137, data filter 139, ruleset processor 141, resting data encryption module 143, and signature processor 145 function substantially as described above with respect to the various aspects of FIGS. 1 and 2.

In an aspect, the collection module 131 is configured to receive data from one or more sensors 103. The types of sensors 103 that may be available to the collection module 131 can depend upon the environment of the system 100. For example, the sensors 103 are mounted upon a device such as, e.g., a remotely controlled robot, or bot, for short, an autonomous bot, or an autonomous vehicle (AV) 102 that is configured to execute the system 100, and/or the sensors 103 may include optical cameras, laser devices, ultrasonic sensors, weather sensors, LIDAR sensors, radar sensors, infrared sensors, and/or near field sensors, etc. An exemplary AV is described in, for example, the system shown and described in U.S. patent application Ser. No. 16/926,522, filed on Jul. 10, 2020, entitled System and Method for Real Time Control of an Autonomous Device (Atty. Dkt. #AA291). In some configurations, a device upon which the system 100 is mounted is mobile. Data received from the one or more sensors 103 are provided to the feature detector 105. The collection module 131 receives a trigger list from the processing module 147 via the communication medium 119.

In an arrangement, a ruleset provider source 123 is coupled to the processing module 147. The ruleset provider source 123 provides one or more rulesets to the processing module 147. The ruleset provider source 123 may be a data store under the control of, for example, but not limited to, a law enforcement agency or other municipality that tracks subjects of interest. Examples of subjects of interest may include, but are not limited to including, people, automobiles, and/or tangible devices. In an aspect, rulesets include information about subjects of interest that can be used by the system 100 to locate the subjects of interest. In an embodiment, rulesets are provided to the ruleset processor 141, which select therefrom a subset of rules, e.g., a trigger list, based at least in part on, for example, but not limited to, the location of the system 100, the time of day, and/or any other factors that could render the selected subset of rules relatively more useful or applicable. In an aspect, the ruleset processor 141 is coupled to the communication medium 119 by way of a transmitter (not shown) such that one or more trigger lists is provided to the collection module 131, and specifically to the feature detector 105 by way of a receiver (not shown). Those of skill would appreciate that one or more trigger lists could, additionally or in the alternative, be provided directly to the collection module 131. In an aspect, the processing module 147 is configured to provide at least one of match notifications and matched sensor data to an application 133 for use by an authorized actor. In an arrangement, the signature processor 145 is configured to provide, by way of a transmitter (not shown), at least one of match notifications and matched sensor data to an application 133 for use by an authorized actor.

In some aspects, data are stored in legally permissible locations, e.g., United States data are not be stored on servers located outside of the United States. In various aspects, data collected by the one or more sensors 103 resides in RAM memory (not shown) until it must be provided to the feature detector 105. In an aspect, each data source retains its own private key that is used to encrypt data sent from that source. In an aspect, authorized system users or entities use a private key in combination with a public key to decrypt data received from an authorized data source. In various configurations, a chain of custody may include one or more of the following example actors: a collection device at rest, a data transfer mechanism, a cloud-based receiver service, a cloud-based detection filter service, a cloud-based notification service, and an end user (e.g., a law enforcement agency).

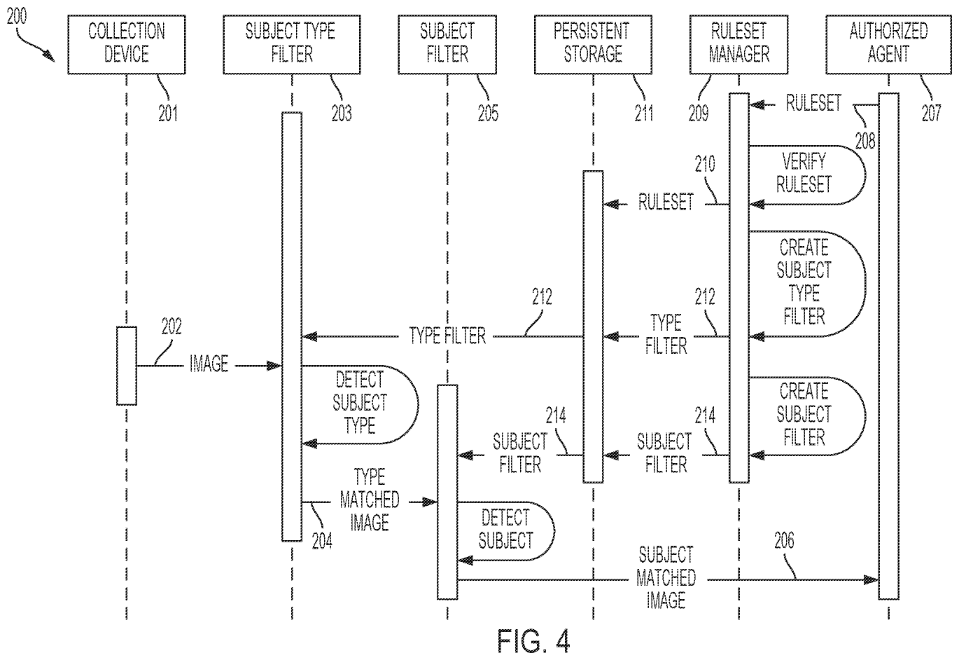

FIG. 4 depicts a message flow 200 according to an example aspect. It would be understood by those skilled in the art that any or all of the various entities shown in FIG. 4 may be either physical or logical entities, may be collocated or remotely located from each other, and/or may be implemented as a single entity or processor. And one of skill would readily appreciate that (in the context of different entities rather than a single entity) any or all of the various messages shown in FIG. 4 may be transmitted/received over any known communication media including but not limited to wired (e.g., Ethernet) and wireless (e.g., WiFi, cellular, satellite) communication media. With reference to FIG. 4, a collection device 201 transmits an image message 202 to a subject type filter module 203. The subject type filter module 203 tries to detect a subject type (determined as described below), e.g., a face or a license plate, in the received image message 202. If the subject type is detected, the subject type filter module 203 transmits a type matched image message 204 to a subject filter module 205. The subject filter module 205 tries to detect a particular subject (determined as described below), e.g., a face of a specific person or a license plate having a specific license plate number, in the received type matched image message 204. If the particular subject is detected, the subject filter module 205 transmits a subject matched image message 206 to an authorized agent 207 (e.g., a law enforcement agency or other municipality).

With continued reference to FIG. 4, the authorized agent 207 transmits a ruleset message 208 to a ruleset manager module 209. The ruleset manager module 209 tries to verify (e.g., authenticate) a ruleset (containing rules defining, for example but not limited to, a subject or item of interest, a set of criteria to use to detect a subject or item of interest, etc.) in the received message 208. If the ruleset manager module 209 verifies the ruleset in the ruleset message 208, the ruleset manager module 209 transmits a verified ruleset message 210 to a persistent storage module 211. The ruleset manager module 209 also creates a subject type filter based at least in part on the verified ruleset. The ruleset manager module 209 transmits a type filter message 212 to the persistent storage module 211. The ruleset manager module 209 also creates a subject filter based at least in part on the verified ruleset. The ruleset manager module 209 transmits a subject filter message 214 to the persistent storage module 211. The persistent storage module 211 transmits the received type filter message 212 to the subject type filter module 203, which uses the received type filter message 212 to detect a subject type in the received image message 202. The persistent storage module 211 also transmits the received subject filter message 214 to the subject filter module 205, which uses the received subject filter message 214 to detect a particular subject in the received type matched image message 204.

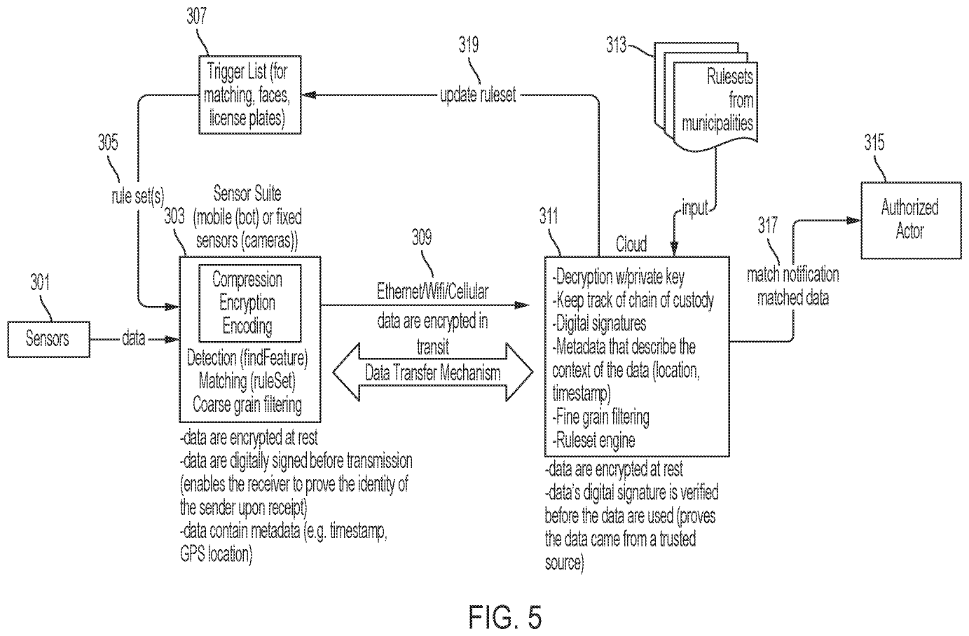

Referring now to FIG. 5, data arrive from sensors 301 to have initial processor 303 performing initial processing. In an aspect, sensors 301 include mobile and/or fixed sensors. In an aspect, mobile sensors are mounted on vehicles such as, for example, but not limited to, wheeled vehicles and/or autonomous vehicles and/or drones, or humans/animals. In an aspect, fixed sensors are mounted at immobile locations, for example, but not limited to, roadways, beacons, traffic lights, traffic signs, buildings, and/or monuments. Sensors 301 can include, but are not limited to including, visual sensors such as cameras, signal sensors such as lidar and ultrasound, audio sensors, tactile sensors, and others. For initial processing 303 to be performed, ruleset(s) 305 are made available from trigger list 307 that is used for matching, for example, faces and license plates. Data processing includes, in some aspects, compression, encryption, and encoding, followed by feature detection, feature matching (with a ruleset), and a first type of filtering, for example, but not limited to, coarse-grain filtering. Data are encrypted at rest and digitally signed before transmission to enable the receiver to prove the identity of the sender upon receipt. The data include metadata, for example a timestamp and GPS location. The processed data are transferred to be used elsewhere and/or stored. With respect to data transfer, only human readable data are sent upon match. Otherwise, encrypted in transit, signed, and encoded (raw) data are sent. The processed data are received by, for example, cloud processor 311 where the data are decrypted with a private key, tracked using a chain of custody strategy, digital signatures, and the metadata. The data are further filtered, for example a fine-grain filter is applied. Cloud processor 311 receives rulesets 313, for example, from municipalities, and processes rulesets 313 to provide updated rulesets 319 to trigger list 307. Cloud processor 311 provides match notification and matched data 317 to authorized actor 315. In cloud processor 311, data are encrypted at rest and the digital signature is verified before the data are used to prove that the data arrives from a trusted source. Cloud processor 311 and/or initial processor 303 store the data. During data storage, data are stored at rest in a legal location, for example, U.S. data cannot be stored on servers outside of the US. The data used by sensors 301 remain in RAM until they need to be transmitted, at which time they are encrypted. Each authorized data source has its own private key that is used to encrypt date from that source. Each authorized user/entity has a unique public key that enables the user/entity to decrypt data received from an authorized data source. Example actors along the data chain of custody can include, but are not limited to including, the bot at rest, data transfer mechanism 309, cloud processor 311 (receiver, detection filter, and notification services), and end user, for example law enforcement. With respect to data integrity, each data source digitally signs each data packet with a unique key. Each data recipient verifies the digital signature for each data packet, verifying that the packet came from an authentic and authorized sender and that the packet has not been tempered with in transit. Each data recipient verifies the data with contextual data, for example, if the matched image is from GPS coordinates x,y, the data recipient verifies that the bot on that trip was at that location at the time reported in the match result. Private keys live with the authorized parties that need them to decrypt the data that they are authorized to see.

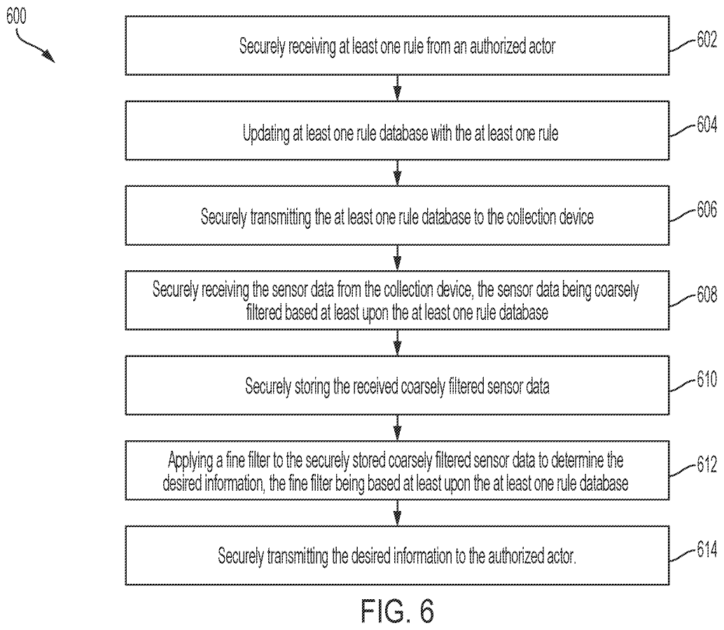

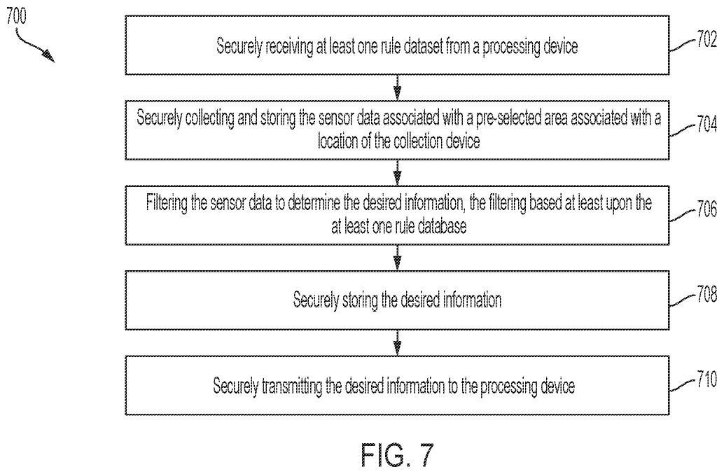

Referring now to FIGS. 6 and 7, methods for determining desired information from the configuration of the present teachings are shown. The method in FIG. 6 is written from the point of view of a processing device that is associated with a collection device that is collecting sensor data, and with a user or another processor that is providing search information. In FIG. 6, method 600 for determining desired information when receiving rule(s) from an authorized actor includes, but is not limited to including, securely receiving 602 at least one rule from the authorized actor. In an aspect, the authorized actor is a law enforcement officer, and the rule is, for example, a warrant that involves locating a vehicle, the warrant including a description by make, model, and license plate number of the desired vehicle. Method 600 includes updating 604 at least one rule database with the at least one rule. In an aspect, the rule database includes information for detecting, for example, vehicles in general, specific makes/models/types of vehicles, license plates in general, and specific license plates. The rule provided by the law enforcement officer provides specific information about a particular vehicle. When the rule is added to the rule database, the database is expanded such that a search for the particular vehicle is possible. Method 600 includes securely transmitting 606 the rule database to the collection device. Although the processing device and the collection device could be co-located, security measures such as resting encryption can ensure that privacy concerns about rule and search data are not compromised. When the processing device and the collection device are communicating through a network, securely transmitting messages that include, for example, legal warrants, includes features such as encryption and man-in-the-middle thwarting, for example. Method 600 includes securely receiving 608 the sensor data from the collection device. The collection device can encrypt in place and encrypt its transmission of the collected data, for example, images of vehicles. In an aspect, the collection device uses the rule database and in particular the rule(s) provided by the law enforcement officer to perform a “coarse” filtering of the collected data. This step, among other things, reduces the amount of data encrypted and transmitted by the collection device to the processing device. The coarse filter can eliminate data that, for example, are not vehicles. In an aspect, eliminating data is defined as deleting all data that do not meet the filter criteria. This step, although optional, protects the privacy of vehicle owners who are not associated with the warrant, and protects the law enforcement agency from privacy violation claims. The coarse filter can be tuned to eliminate data that are not vehicles of the desired make/model/type, and/or vehicles that do not have license plates. The filter can be tuned according to the processing power of the collection device and, if applicable, the transmission rate of the communication link between the collection device and the processing device. Method 600 includes securely storing 610 the received coarsely filtered data. In an aspect, storage is not required. However, if the data are stored, resting encryption protects the data from unauthorized access and therefore protects the privacy of, for example, the owner of the vehicle. Method 600 includes applying 612 a fine filter to the securely-stored, coarsely-filtered data. For example, if the data include the vehicles of the desired make/model/type, the fine filter can examine the data further for a match for the desired license plate. Method 600 includes securely transmitting 614 the desired information to the authorized actor. In the example herein, the law enforcement officer is provided the location of the desired vehicle through, for example, an encrypted transmission. In an aspect, other data that are not the desired information are deleted permanently from the processing device's storage area(s).

Referring now to FIG. 7, method 700 for searching for and providing desired information is executing in the collection device. Method 700 includes securely receiving 702 at least one ruleset database from the processing device which has received information from an authorized actor and has used that information to update the database. Method 700 includes securely collecting 704 and storing sensor data associated with a pre-selected area associated with the location of the collection device, thus effectively location-tagging the collected data. Method 700 includes filtering 706 the collected data according to the “triggers” (coarse filtering) from the ruleset database. As discussed herein, such filtering includes, for example, sorting vehicles from other data, but could include any threshold, including sorting vehicle license plates from each other, or even locating a specific desired license plate location. Method 700 includes securely storing 708 the filtered data, and securely transmitting 710 the filtered data to the processing device. In an aspect, the filtered data are securely transmitted but not stored. Thus, the data are either deleted when they don't meet the trigger criteria, or deleted after or as they are securely transmitted to the processing device.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for identifying desired information from sensor data collected by a collection device. The method also includes securely receiving at least one rule from an authorized actor; determining at least one coarse filter based on the at least one rule; updating at least one rule database with the at least one rule; securely transmitting the at least one coarse filter to the collection device; securely receiving the sensor data from the collection device, the sensor data being filtered by the at least one coarse filter. The method also includes determining the desired information by applying a fine filter to the filtered sensor data, the fine filter being based at least upon the at least one rule database. The method also includes encrypting and transmitting the desired information to the authorized actor. Other embodiments of this aspect include corresponding computer systems, apparatus, and computer programs recorded on one or more computer storage devices, each configured to perform the actions of the methods.

Implementations may include one or more of the following features. The method as may include: encrypting in place and storing the received coarsely filtered sensor data. The coarse filter may include: at least one feature of interest. The at least one feature of interest may include: height of a subject. The at least one feature of interest may include: model of a vehicle. The at least one feature of interest may include: color of a vehicle. The authorized actor may include: a law enforcement agency. The at least one rule may include: a rule generated at least in part from a warrant from the authorized actor. The desired information may include: an identity of a subject. The desired information may include: a license plate number. The method may include: securely deleting all the coarsely filtered sensor data after securely transmitting the desired information to the authorized actor. Implementations of the described techniques may include hardware, a method or process, or computer software on a computer-accessible medium.

One general aspect includes a method for identifying desired information from sensor data collected by a collection device. The method also includes securely receiving at least one rule dataset from a processing device; securely receiving and storing the sensor data associated with a pre-selected area associated with a location of the collection device. The method also includes filtering the sensor data to determine the desired information, the filtering based at least upon the at least one rule database; securely storing the desired information. The method also includes securely transmitting the desired information to the processing device. Other embodiments of this aspect include corresponding computer systems, apparatus, and computer programs recorded on one or more computer storage devices, each configured to perform the actions of the methods.

Implementations may include one or more of the following features. The method may include: compressing the desired information. The method may include: encrypting the desired information. The method may include: encoding the desired information. The filtering may include: filtering the sensor data to determine human subjects, the filtering based at least upon the at least one rule database. The filtering may include: filtering the sensor data to determine license plate numbers, the filtering based at least upon the at least one rule database. Implementations of the described techniques may include hardware, a method or process, or computer software on a computer-accessible medium.

One general aspect includes a system for identifying desired information from sensor data collected by a collection device. The system also includes at least one sensor mounted upon the autonomous vehicle; and a collection module executing on the processor, the collection module configured to securely receive at least one rule dataset, the collection module configured to securely receive and store sensor data associated with a pre-selected area associated with a location of the autonomous vehicle, the collection module configured to filter, based at least upon the at least one rule database, the sensor data to determine the desired information, the collection module configured to securely store the desired information, and the collection module configured to securely transmit the desired information. Other embodiments of this aspect include corresponding computer systems, apparatus, and computer programs recorded on one or more computer storage devices, each configured to perform the actions of the methods.

Implementations may include one or more of the following features. The system where the collection module is configured to compress the desired information. Implementations of the described techniques may include hardware, a method or process, or computer software on a computer-accessible medium.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for identifying desired information from sensor data collected by a collection device a processing module including processing module computer instructions for: securely receiving at least one rule from an authorized actor; updating at least one rule database with the at least one rule; securely transmitting the at least one rule database to the collection device; securely receiving intermediate coarsely filtered data from the collection device, the intermediate coarsely filtered data being coarsely filtered based at least upon the at least one rule database; securely storing the received intermediate coarsely filtered sensor data; applying a fine filter to the securely stored intermediate coarsely filtered sensor data to determine the desired information, the fine filter being based at least upon the at least one rule database; securely transmitting the desired information to the authorized actor; and securely deleting all the intermediate coarsely filtered sensor data; a collection module configured to execute on the collection device, the collection module including collection module computer instructions for: securely receiving the at least one rule dataset from a processing device executing the processing module computer instructions; securely receiving and storing sensor data associated with a pre-selected area associated with a location of the collection device; coarsely filtering the sensor data to determine the intermediate coarsely filtered sensor data, the coarsely filtering based at least upon the at least one rule database; securely storing the intermediate coarsely filtered sensor data; securely transmitting the intermediate coarsely filtered sensor data to the processing module; a user interface configured to receive the at least one rule from the authorized actor; and a communications gateway configured to enable secure communications among the user interface, the processing module, and the collection module. Other embodiments of this aspect include corresponding computer systems, apparatus, and computer programs recorded on one or more computer storage devices, each configured to perform the actions of the methods.

Implementations may include one or more of the following features. The system where the collection module is configured to delete all sensor data after securely transmitting the coarsely filtered sensor data to the processing module. The secure communications may include encrypted communications. Implementations of the described techniques may include hardware, a method or process, or computer software on a computer-accessible medium.

One general aspect includes a method for identifying desired information from sensor data collected by a collection device. The method also includes securely receiving at least one rule dataset from a processing device; securely receiving and storing the sensor data associated with a pre-selected area associated with a location of the collection device. The method also includes filtering the sensor data to determine the desired information, the filtering based at least upon the at least one rule database; securely storing the desired information. The method also includes securely transmitting the desired information to the processing device. Other embodiments of this aspect include corresponding computer systems, apparatus, and computer programs recorded on one or more computer storage devices, each configured to perform the actions of the methods.

Implementations may include one or more of the following features. The method may include: compressing the desired information. The method may include: encrypting the desired information. The method may include: encoding the desired information. The filtering may include: filtering the sensor data to determine human subjects, the filtering based at least upon the at least one rule database. The filtering may include: filtering the sensor data to determine license plates, the filtering based at least upon the at least one rule database. Implementations of the described techniques may include hardware, a method or process, or computer software on a computer-accessible medium.

One general aspect includes a system for identifying desired information from sensor data collected by a collection device. The system also includes at least one sensor mounted upon the autonomous vehicle; and a collection module executing on the processor, the collection module configured to securely receive at least one rule dataset, the collection module configured to securely receive and store sensor data associated with a pre-selected area associated with a location of the autonomous vehicle, the collection module configured to filter, based at least upon the at least one rule database, the sensor data to determine desired information, the collection module configured to securely store the desired information, and the collection module configured to securely transmit the desired information. Other embodiments of this aspect include corresponding computer systems, apparatus, and computer programs recorded on one or more computer storage devices, each configured to perform the actions of the methods.

Implementations may include one or more of the following features. The system where the collection module is configured to compress the desired information. The collection module is configured to encrypt the desired information. The collection module is configured to encode the desired information. The desired information may include: data associated with human subjects. The desired information may include: data associated with license plates. Implementations of the described techniques may include hardware, a method or process, or computer software on a computer-accessible medium.

One general aspect includes a system for identifying desired information from sensor data collected by a collection device a processing module including processing module computer instructions for: securely receiving at least one rule from an authorized actor; updating at least one rule database with the at least one rule; securely transmitting the at least one rule database to the collection device; securely receiving intermediate coarsely filtered data from the collection device, the intermediate coarsely filtered data being coarsely filtered based at least upon the at least one rule database; securely storing the received intermediate coarsely filtered sensor data; applying a fine filter to the securely stored intermediate coarsely filtered sensor data to determine the desired information, the fine filter being based at least upon the at least one rule database; securely transmitting the desired information to the authorized actor; and securely deleting all the intermediate coarsely filtered sensor data; a collection module configured to execute on the collection device, the collection module including collection module computer instructions for: securely receiving the at least one rule dataset from a processing device executing the processing module computer instructions; securely receiving and storing sensor data associated with a pre-selected area associated with a location of the collection device; coarsely filtering the sensor data to determine the intermediate coarsely filtered sensor data, the coarsely filtering based at least upon the at least one rule database; securely storing the intermediate coarsely filtered sensor data; securely transmitting the intermediate coarsely filtered sensor data to the processing module; a user interface configured to receive the at least one rule from the authorized actor; and a communications gateway configured to enable secure communications among the user interface, the processing module, and the collection module. Other embodiments of this aspect include corresponding computer systems, apparatus, and computer programs recorded on one or more computer storage devices, each configured to perform the actions of the methods.

Implementations may include one or more of the following features. The system where the desired information may include: data associated with human subjects. The desired information may include: data associated with license plates. The collection module is configured to delete all sensor data after securely transmitting the coarsely filtered sensor data to the processing module. The secure communications may include encrypted communications. The collection module is configured to encode the desired information. The method where the at least one rule may include:. The method includes a rule generated at least in part from a warrant from the authorized actor, the authorized actor being a law enforcement agency. The method further. The method includes determining an identity of a subject based at least on a result from the fine filter. The method further. The method includes determining a license plate number based at least on a result from the fine filter. The method further. The method includes securely deleting all the intermediate coarsely filtered sensor data after securely transmitting the desired information to the authorized actor. Implementations of the described techniques may include hardware, a method or process, or computer software on a computer-accessible medium.

Implementations may include one or more of the following features. The method where the at least one rule may include:. The method includes a rule generated at least in part from a warrant from the authorized actor, the authorized actor being a law enforcement agency. The method further. The method includes determining an identity of a subject based at least on a result from the fine filter. The method further. The method includes determining a license plate number based at least on a result from the fine filter. The method further. The method includes securely deleting all the intermediate coarsely filtered sensor data after securely transmitting the desired information to the authorized actor. Implementations of the described techniques may include hardware, a method or process, or computer software on a computer-accessible medium.

In various aspects a system may enable law enforcement or related authorities that use the system to dictate to the system what the system should search for. The system may actively patrol, and to the extent a law enforcement agency has the authority, the law enforcement agency may tell the system to look for specific things, such as, e.g., particular faces, sounds, car models, license plates, etc. The system may also be told to include items such as, e.g., location and/or time of day. The system may also be configured to note the absence in a detected scene of items that should ordinarily be present. As a non-limiting example, the system may detect the absence of a truck in a lot at which five trucks are supposed to be parked and only four trucks are parked. A collection device of the system may in some configurations be collocated with, or housed within or on, or executed by, an autonomous vehicle. A non-limiting example of a suitable autonomous vehicle is described in U.S. patent application Ser. No. 16/435,007, filed on Jun. 7, 2019, entitled System and Method for Distributed Utility Service Execution (Atty. Dkt. #AA001), fully incorporated herein by reference. The collection module may perform a relatively coarse grain filter on collected data, and may transmit only desired data such that no data that is not desired is transmitted. The collection module may be configured to downsample data in real time as the data are being collected, such that, e.g., in a set of collected images that depict the same item (and add little to no useful information with respect to each other such that, for example, each differs from its most proximate neighbor by less than a threshold percentage or absolute delta), only one or a subset of such collected images is transmitted. In addition, the collection module may be configured to compress data to be transmitted in order to save bandwidth. The collection module may be configured, upon detecting a matching image to a desired subject or item, to send a window of images around the matched image starting with an image that was detected at a time before the matching image was detected, and ending at an image that was detected at a time after the matching image was detected. The collection module may be configured to encrypt all data to be transmitted. A fine grain filter may be performed at a processing module to which the collection module has transmitted data. As a non-limiting example, the processing module may be located in the cloud. The relative coarseness and relative fineness of the filter processing may be adjusted, for example, relative to each other, as needed for system optimization. Additionally or in the alternative, the relative coarseness of the filtering performed at the collection module may be adjusted based at least in part on the type of object desired and/or on privacy expectations associated with the desired object. For example, some types of objects, e.g., particular faces, may be more difficult to reliably detect than other types of objects, e.g., license plates. For example, some types of objects, e.g., particular faces, may be associated with heightened privacy expectations as compared to other types of objects, e.g., license plates.

In at least one arrangement, a processing module may create a ruleset. An authorized agent may authenticate to a web-based application that enables the authorized agent to create a new ruleset. Additionally or in the alternative, a trusted external system may create a new ruleset via a Representational State Transfer (REST) application programming interface (API). In at least one arrangement, a ruleset may include at least the following rule information: (i) a Subject/Rule Identifier that associates the rule and any result with the agent, or with the agent's system of record (e.g., a warrant number, a case number, etc.); (ii) a Subject Type (e.g., person, vehicle license plate, etc.); (iii) a Compared Subject (e.g., person image, license plate number); (iv) a Search Effective date/time; (v) a Search Expiration date/time; and (vi) a Search Location(s). A web-based application may verify the information provided and create a filter object based on the subject type and compared subject inputs. In some aspects, a person filter object may not contain images of the subject. A collection module may detect any/all persons rather than a specific person, so a facial recognition module may reside in the cloud such that the subject image need not be sent to the collection module. In some aspects, a license plate filter object may contain an alphanumeric string. In some aspects, information in the ruleset about Subject Type may be in the form of a JavaScript Object Notation (JSON) object.

In at least one arrangement a processing module may assign one or more rulesets to one or autonomous devices, e.g., robots, or bots for short. The bots may incorporate data collection modules. A web-based application may select a list of active bot(s) that are located within a search location specified in a database of current bot locations. In some aspects, the system may encrypt a filter package using the AES encryption algorithm at 256-bit strength. Additionally, or in the alternative, the web-based application may transmit the filter package to selected bots using Transport Layer Security (TLS) 1.2.

In at least one arrangement, a collection module may collect images of objects detected that match the ruleset Subject Type (e.g., person, license plate number). In some aspects, the system may coarsely filter objects based on the ruleset. For example, if a ruleset defines that the object of interest has license number plate x, the system may filter only vehicles (cars, trucks, bikes, etc.) within all detected objects. In some aspects, the system may provide a two dimensional (2D)-bounding box tracking mechanism such as, e.g., Generalized Intersection Over Union (GIOU) tracking, to track persons or vehicles and their respective bounding boxes from one image frame to the next. In some aspects, the system may crop some or all sections of an image, by way of non-limiting example, within a person's bounding box(es). The system may send to a processing module at least one such cropped image pertaining to each detected and tracked object of the type Person or License Plate number. In some aspects, the system may encode and/or encrypt the cropped image data before sending the cropped image data to a processing module.

In at least one arrangement, a processing module may receive and process cropped images of subjects detected and tracked within a location and time specified by a ruleset. In some aspects, the system may decrypt and/or decode the cropped images generated by a collection module and provided to a processing module. Processing may continue in the event that data is valid, i.e., that data can be decrypted and decoded. Invalid data, i.e., data that cannot be decrypted or decoded, may be deleted. In some aspects, the system may verify that a timestamp and/or a GPS location of a cropped image is or are within boundaries indicated by a search warrant, delete invalid data, and store valid data for further processing.

In at least one arrangement, a processing module may receive and process cropped images of license plates detected and tracked within a location and time specified by a ruleset. In some aspects, the system may decrypt and/or decode the cropped images generated by a collection module and provided to a processing module. The system may provide at least one decoded, cropped image as input(s) to a neural network algorithm that may generate at least one bounding box containing at least one license plate as output(s). In some aspects, the system may further crop detected license plates from each input to the neural network algorithm for further processing. Cropped images containing license plates may, in some aspects, be subjected to optical character recognition algorithms to output as text an alphanumeric on a license plate. In some aspects, the system may perform text matching between generated text and a license plate number described in a filter ruleset to classify the text as a match or as a non-match.

In at least one arrangement, a processing module may receive and process cropped images of subjects detected and tracked within a location and time specified by a ruleset. In some aspects, the system may decrypt and/or decode the cropped images generated by a collection module and provided to a processing module. The system may provide at least one decoded, cropped image as input(s) to a neural network algorithm that may generate at least one bounding box containing at least one facial image as output(s). In some aspects, the system may further crop detected facial images from each input to the neural network algorithm for further processing.

In at least one arrangement the system may encrypt and store each cropped image that contains matched text or matched images.

In at least one arrangement, an authorized agent may view information for a matched subject or a match event. A processing module may notify the authorized agent of a matched subject. In some aspects, the processing module may create and store an encrypted package that contains GPS coordinates and/or timestamps and/or images and/or text associated with a matched subject. The system may notify the authorized agent by sending an SMS message, and/or an /email message, the message containing a URL link to a web-based application. Additionally or in the alternative, the system may notify the authorization by sending a notification to a trusted third party web service via a message queue.

In at least one arrangement, an authorized agent may view and/or download and/or ingest matched subject data. The agent may authenticate to a web-based application and view and/or download matched subject data thereby. Additionally or in the alternative, a processing module may send an access token to a trusted third party to use to retrieve an encrypted package.

In at least one arrangement, facial recognition and/or text recognition modules may be trained periodically in order to maintain a threshold prediction accuracy rate over time. In some aspects, the prediction confidence threshold may be initially set to a relatively low level, generating more false positives, and be raised over time as the models become more accurate, generating fewer overall matches.

In at least one arrangement, a confidence level threshold for filtering data, for example, for determining whether to validate and retain or invalidate and discard data, may be set at 85%. In some aspects, any data that cannot be decrypted or decoded may be discarded. In some aspects, any data for which the source, by way of non-limiting example, a bot, cannot be authenticated, may be discarded. In some aspects, any data that is outside the scope of, e.g., a warrant, may be discarded.

In at least one arrangement, security measures may be maintained between a bot with a collection module and a remote controller operator of the bot. By way of non-limiting example, a remote control operator may be required to authenticate with a username and password to access a remote control console. In some aspects, the remote control console may include a web browser that may transmit a connection request, the request may be encrypted using the AES encryption algorithm at 256 bit strength, and the request may be transmitted using Transport Layer Security (TLS) 1.2. In some aspects, the remote control console and bot identities may be authenticated by a connection broker prior to the creation of a peer-to-peer connection. As a non-limiting example, a web browser of the remote control console may establish a secure, peer-to-peer connection with a bot over WebRTC. In some aspects, video from the remote control console display may be streamed to a browser over WebRTC, and may not be stored in the web browser or on the remote console or a remote console host machine.

Those of skill would understand that the methods described in the subject disclosure may be applied to computer systems configured to accomplish such methods, and/or to computer-readable media containing programs to accomplish such methods, and/or to software and/or firmware and/or hardware (e.g., integrated circuits) designed to accomplish such methods. Raw data and/or results may be stored for future retrieval and processing, printed, displayed, transferred to another computer, and/or transferred elsewhere. Communication links may be wired or wireless including by way of non-limiting example Ethernet, cellular or broadband networks, WiFi or local area networks, military communications systems, and/or satellite communications systems. Parts of a system may, for example, operate on a computer having a variable number of CPUs. Other alternative computer platforms can be used.

As one skilled in the art would understand, the methods described in the subject disclosure may be, in whole or in part, implemented electronically. Signals representing actions taken by elements of the system of the subject disclosure, and other disclosed configurations, may travel over at least one live communications network. Control and data information may be electronically executed and stored on at least one computer-readable medium. The system may be implemented to execute on at least one computer node in at least one live communications network. Common forms of computer-readable media can include, for example, but not be limited to, a floppy disk, a flexible disk, a hard disk, magnetic tape or any other magnetic medium, a compact disk read only memory or any other optical medium, punched cards, paper tape, or any other physical medium with patterns of holes, a random access memory, a programmable read only memory, an erasable programmable read only memory (EPROM), a Flash EPROM or any other memory chip or cartridge, or any other medium from which a computer can read.

Those of skill in the art would understand that information and signals may be represented using any of a variety of different existing techniques. For example, data, instructions, commands, information, signals, bits, symbols, or chips that may be referenced throughout the description may be represented by voltages, currents, electromagnetic waves, magnetic fields or particles, optical fields or particles, ultrasonic waves, projected capacitance, or any combination thereof.

Those of skill would further appreciate that the various illustrative logical blocks, modules, circuits, and algorithm steps described in connection with the arrangements disclosed herein may be implemented as electronic hardware, computer software, or combinations of both. To clearly illustrate this interchangeability of hardware and software, various illustrative components, blocks, modules, circuits, and steps have been described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the appended claims.

The various illustrative logical blocks, modules, and circuits described in connection with the arrangements disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The actions of a method or algorithm described in connection with the arrangements disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in functional equipment such as, e.g., a computer, a robot, a user terminal, a mobile telephone or tablet, a car, or an IP camera. In the alternative, the processor and the storage medium may reside as discrete components in such functional equipment.

The above description is not intended to be exhaustive or to limit the features to the precise forms disclosed. Various alternatives and modifications can be devised by those skilled in the art without departing from the disclosure, and the generic principles defined herein may be applied to other aspects without departing from the spirit or scope of the appended claims. Accordingly, the present disclosure is intended to embrace all such alternatives, modifications and variances. Additionally, while several arrangements of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as examples of particular configurations. And those skilled in the art will envision other modifications within the scope and spirit of the claims appended hereto. Other elements, steps, actions, methods, and techniques that are not substantially different from those described above and/or in the appended claims are also intended to be within the scope of the disclosure. Thus, the appended claims are not intended to be limited to the arrangements shown and described herein, but are to be accorded the broadest scope consistent with the principles and novel features disclosed herein.

The arrangements shown in drawings are presented only to demonstrate certain examples of the disclosure. And, the drawings described are merely illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes,” “has,” “possesses,” and the like are used in the present description and claims, such terms are intended to be inclusive in a manner similar to the term “comprising,” as “comprising” is interpreted when employed as a transitional word in a claim.

Furthermore, the terms “first”, “second”, “third” and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the embodiments of the disclosure described herein are capable of operation in other sequences and/or arrangements than are described or illustrated herein.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for identifying desired information from sensor data collected by a collection device. The method also includes securely receiving at least one rule from an authorized actor; updating at least one rule database with the at least one rule; securely transmitting the at least one rule database to the collection device; securely receiving the sensor data from the collection device, the sensor data being coarsely filtered based at least upon the at least one rule database; securely storing the received coarsely filtered sensor data. The method also includes applying a fine filter to the securely stored coarsely filtered sensor data to determine the desired information, the fine filter being based at least upon the at least one rule database. The method also includes securely transmitting the desired information to the authorized actor. Other embodiments of this aspect include corresponding computer systems, apparatus, and computer programs recorded on one or more computer storage devices, each configured to perform the actions of the methods.

Implementations may include one or more of the following features. The method where the at least one rule may include: a rule generated at least in part from a warrant from the authorized actor, the authorized actor being a law enforcement agency. The method may include: determining an identity of a subject based at least on a result from the fine filter. The method may include: determining a license plate number based at least on a result from the fine filter. The method may include: securely deleting all the intermediate coarsely filtered sensor data after securely transmitting the desired information to the authorized actor. Implementations of the described techniques may include hardware, a method or process, or computer software on a computer-accessible medium.

One general aspect includes a method for identifying desired information from sensor data collected by a collection device. The method also includes securely receiving at least one rule dataset from a processing device; securely receiving and storing the sensor data associated with a pre-selected area associated with a location of the collection device. The method also includes filtering the sensor data to determine the desired information, the filtering based at least upon the at least one rule database; securely storing the desired information. The method also includes securely transmitting the desired information to the processing device. Other embodiments of this aspect include corresponding computer systems, apparatus, and computer programs recorded on one or more computer storage devices, each configured to perform the actions of the methods.

Implementations may include one or more of the following features. The method may include: compressing the desired information. The method may include: encrypting the desired information. The method may include: encoding the desired information. The filtering may include: filtering the sensor data to determine human subjects, the filtering based at least upon the at least one rule database. The filtering may include: filtering the sensor data to determine license plates, the filtering based at least upon the at least one rule database. Implementations of the described techniques may include hardware, a method or process, or computer software on a computer-accessible medium.

One general aspect includes a system for identifying desired information from sensor data collected by a collection device. The system also includes at least one sensor mounted upon the autonomous vehicle; and a collection module executing on the processor, the collection module configured to securely receive at least one rule dataset, the collection module configured to securely receive and store sensor data associated with a pre-selected area associated with a location of the autonomous vehicle, the collection module configured to filter, based at least upon the at least one rule database, the sensor data to determine desired information, the collection module configured to securely store the desired information, and the collection module configured to securely transmit the desired information. Other embodiments of this aspect include corresponding computer systems, apparatus, and computer programs recorded on one or more computer storage devices, each configured to perform the actions of the methods.

Implementations may include one or more of the following features. The system where the collection module is configured to compress the desired information. The collection module is configured to encrypt the desired information. The collection module is configured to encode the desired information. The desired information may include: data associated with human subjects. The desired information may include: data associated with license plates. Implementations of the described techniques may include hardware, a method or process, or computer software on a computer-accessible medium.

One general aspect includes a system for identifying desired information from sensor data collected by a collection device a processing module including processing module computer instructions for: securely receiving at least one rule from an authorized actor; updating at least one rule database with the at least one rule; securely transmitting the at least one rule database to the collection device; securely receiving intermediate coarsely filtered data from the collection device, the intermediate coarsely filtered data being coarsely filtered based at least upon the at least one rule database; securely storing the received intermediate coarsely filtered sensor data; applying a fine filter to the securely stored intermediate coarsely filtered sensor data to determine the desired information, the fine filter being based at least upon the at least one rule database; securely transmitting the desired information to the authorized actor; and securely deleting all the intermediate coarsely filtered sensor data; a collection module configured to execute on the collection device, the collection module including collection module computer instructions for: securely receiving the at least one rule dataset from a processing device executing the processing module computer instructions; securely receiving and storing sensor data associated with a pre-selected area associated with a location of the collection device; coarsely filtering the sensor data to determine the intermediate coarsely filtered sensor data, the coarsely filtering based at least upon the at least one rule database; securely storing the intermediate coarsely filtered sensor data; securely transmitting the intermediate coarsely filtered sensor data to the processing module; a user interface configured to receive the at least one rule from the authorized actor; and a communications gateway configured to enable secure communications among the user interface, the processing module, and the collection module. Other embodiments of this aspect include corresponding computer systems, apparatus, and computer programs recorded on one or more computer storage devices, each configured to perform the actions of the methods.

Implementations may include one or more of the following features. The system where the collection module is configured to delete all sensor data after securely transmitting the coarsely filtered sensor data to the processing module. Implementations of the described techniques may include hardware, a method or process, or computer software on a computer-accessible medium.

What is claimed is:

1. A method for identifying desired information from sensor data collected by a collection device, the method comprising:
securely receiving at least one rule from an authorized actor;
determining at least one first filter based on the at least one rule;
updating at least one rule database with the at least one rule;
securely transmitting the at least one first filter to the collection device;
securely receiving the sensor data from the collection device, the sensor data being filtered by the at least one first filter;
determining the desired information by applying at least one second filter to the filtered sensor data, the at least one second filter being based at least upon the at least one rule database; and
encrypting and transmitting the desired information to the authorized actor.

2. The method as in claim 1 further comprising:
encrypting in place and storing the received first filtered sensor data.

3. The method as in claim 1 wherein the at least one first filter comprises:
at least one feature of interest.

4. The method of claim 3 wherein the at least one feature of interest comprises:
height of a subject.

5. The method of claim 3 wherein the at least one feature of interest comprises:
model of a vehicle.

6. The method of claim 3 wherein the at least one feature of interest comprises:
color of a vehicle.

7. The method as in claim 1 wherein the authorized actor comprises:
a law enforcement agency.

8. The method of claim 1 wherein the at least one rule comprises:
a rule generated at least in part from a warrant from the authorized actor.

9. The method of claim 1 wherein the desired information comprises:
an identity of a subject.

10. The method of claim 1 wherein the desired information comprises:
a license plate number.

11. The method of claim 1 further comprising:
securely deleting all the first filtered sensor data after securely transmitting the desired information to the authorized actor.

12. A method for identifying desired information from sensor data collected by a collection device, the method comprising:
securely receiving at least one rule dataset from a processing device;
securely receiving and storing the sensor data associated with a pre-selected area associated with a location of the collection device;
filtering the sensor data to determine the desired information, the filtering based at least upon the at least one rule database;
securely storing the desired information; and
securely transmitting the desired information to the processing device.

13. The method of claim 12 further comprising:
compressing the desired information.

14. The method of claim 12 further comprising:
encrypting the desired information.

15. The method of claim 12 further comprising:
encoding the desired information.

16. The method of claim 12 wherein the filtering comprises:
filtering the sensor data to determine human subjects, the filtering based at least upon the at least one rule database.

17. The method of claim 12 wherein the filtering comprises:
filtering the sensor data to determine license plate numbers, the filtering based at least upon the at least one rule database.

18. A system for identifying desired information from sensor data collected by at least one sensor, the at least one sensor being associated with a collection device, the system executing on a processor, the processor located in an autonomous vehicle, the system comprising:
a collection module executing on the processor, the collection module configured to securely receive at least one rule dataset, the collection module configured to securely receive and store the sensor data associated with a pre-selected area associated with a location of the autonomous vehicle, the collection module configured to filter, based at least upon the at least one rule database, the sensor data to determine the desired information, the collection module configured to securely store the desired information, and the collection module configured to securely transmit the desired information.

19. The system of claim 18 wherein the collection module is configured to compress the desired information.

20. The system of claim 18 wherein the collection module is configured to encrypt the desired information.
